(19) United States
(12) Patent Application Publication
(10) Pub. No.: US 2009/0062443 A1
(43) Pub. Date: Mar. 5, 2009

(54) Polymeric Materials

(76) Inventors: David Kemmish, Lancashire (GB); Steven John Moloney, Merseyside (GB); Stephen Leeming, Manchester (GB); Gonzalo Sandoval, Manchester (GB)

Correspondence Address: Fay Sharpe LLP, 1228 Euclid Avenue, 5th Floor, The Halle Building, Cleveland, OH, 44115-1843, US

(21) Appl. No.: 12/087,716

(22) PCT Filed: Dec. 22, 2006
(86) PCT No.: PCT/GB2006/004938

§ 371 Date: Nov. 4, 2008

(30) Foreign Application Priority Data
Dec. 23, 2005 (GB) 0526260.5

(51) Int. Cl. C08K 5/20; C08K 5/17; C08K 3/22

(52) U.S. Cl. 524/217; 524/236; 524/80; 524/445

(57) ABSTRACT

There is described the use of an acetaldehyde decreasing compound in a thermoplastic composition which comprises: (i) a polyester; and (ii) at least one property improving material selected from a compound containing an amino moiety, a nano clay and/or a quaternary ammonium compound; for reducing the degree of discolouration and/or increasing the degree of light transmission of an article formed from the thermoplastic composition. A preferred acetaldehyde decreasing compound is anthranilamide.

This invention relates to polymeric materials and particularly, although not exclusively, relates to polyester-containing materials.

It is known, for example from GB2207439A(CMB), to provide blends of polyester, especially polyethylene terephthalate (PET), and polyamides to produce barrier layers for single layer or multi-layer PET bottles. However, a problem with known materials is their tendency to haze and/or yellow when heated, for example in injection moulding and/or blow moulding to produce bottles. This may disadvantageously limit the applications of the blends to production of bottles or other materials which are coloured and/or to other applications wherein the haze/yellowing can be tolerated.

More recently, nano clays have been proposed for use in barrier technology. For example, Eastman Chemical Co, US has developed a technology wherein nanometer sized clay platelets are dispersed in a PET resin matrix. Bottles may be moulded from the material. Disadvantageously, the material produced exhibits significant haze and/or yellowing which means that the technology may not be acceptable for clear bottles (or other materials) but may only be acceptable for amber (or other coloured) bottles.

The increase in haze and/or yellowing when polyamides are incorporated into PET is significantly higher than the haze and/or yellowing of PET in the absence of the polyamides. Furthermore, the higher levels of haze and/or yellowing cannot be attributed solely to levels which would be imparted by polyamides. There appears to be synergism between the polyester and polyamides which disadvantageously tends to increase haze and/or yellowing.

It is an object of the present invention to address the above described problems.

It is another object of the present invention to provide a means for reducing haze and/or yellowing in PET composites.

According to a first aspect of the invention, there is provided the use of an acetaldehyde decreasing compound in a thermoplastic composition which comprises:

(i) a polyester; and
(ii) at least one material selected from a compound containing an amino moiety, a nano clay and/or a quaternary ammonium compound;
for reducing the degree of discolouration and/or increasing the degree of light transmission of an article formed from the thermoplastic composition.

Said acetaldehyde decreasing compound is suitably arranged to decrease the level of acetaldehyde in the thermoplastic composition either by reacting with the acetaldehyde or promoting a reaction of the acetaldehyde.

Said acetaldehyde decreasing compound may be an acetaldehyde scavenger, or a catalyst or promoter of a chemical reaction involving acetaldehyde. In both cases, the acetaldehyde decreasing compound suitably reduces the level of acetaldehyde in the composition. Said acetaldehyde decreasing compound is preferably an acetaldehyde scavenger.

Preferred acetaldehyde scavengers include one or more nitrogen atoms. Preferably, the nitrogen atoms are not bonded to other atoms by double or triple bonds, but are preferably bonded to three other atoms by single bonds. Preferred scavengers include amine moieties. Preferred amine moieties are primary and secondary amine moieties. Especially preferred are scavengers which include a —NH₂ moiety.

In one embodiment, preferred acetaldehyde scavengers include both amine moieties as described and amide moieties. In one embodiment, preferred acetaldehyde scavengers include a substituted phenyl moiety. In one preferred embodiment, a said acetaldehyde scavenger may include an amine moiety (especially —NH₂), an amide moiety (especially —CONH₂) and a substituted phenyl moiety. In this case, it is preferred that both the amine moiety and the amide moiety are directly bonded to the phenyl moiety. Preferably, the amine moiety and amide moiety are bonded ortho to one another.

Another class of acetaldehyde scavengers may be as described in U.S. Pat. No. 6,762,275 (Coca-Cola), the content of which as regards the scavenger is incorporated herein by reference. In this case, the scavenger may include at least two component molecular fragments, each component molecular fragment comprising at least two hydrogen substituted heteroatoms bonded to carbons of the respective component molecular fragment. The component molecular fragments of the organic additive compound are each reactive with acetaldehyde to form water and a resulting organic molecular fragment comprising an unbridged five or six member ring including the at least two heteroatoms. Preferably, the organic additive compounds have at least twice the molecular weight of the component molecular fragments alone. The heteroatoms present in each molecular fragment capable of reacting with acetaldehyde include oxygen (O), nitrogen (N), and sulfur (S). The heteroatoms of the component molecular fragments suitably have at least one bond to an active hydrogen (H), and in the course of condensing with acetaldehyde should split off water. Preferred functional groups containing these heteroatoms include amine (NH2 and NHR), hydroxyl (OH), carboxyl (CO2H), amide (CONH2 and CONHR), sulfonamide (SO2NH2), and thiol (SH). It is necessary for these functional groups to be sterically arranged so that on condensation with AA an unbridged 5 or 6 member ring can be formed. It is preferred that the structural arrangement allows the formation of a six membered ring. It is especially preferred that heteroatoms of the organic additive are attached to a preformed ring or rings. It is most preferred that the preformed ring(s) are aromatic so that the unbridged 5 or 6-member ring of the resulting organic compound is bonded to the aromatic ring. Suitable organic additive compounds may be substantially thermally stable at the temperatures required for melt-processing the polyester. It is also preferred that the functional groups present on the organic additive are relatively unreactive towards the ester linkages present in polyesters. Examples of preferred scavengers include 1,2-bis(2-aminobenzamidoyl)ethane; 1,2-bis(2-aminobenzamidoyl)propane; 1,3-bis(2-aminobenzamidoyl)propane; 1,3-bis(2-aminobenzamidoyl)pentane; 1,5-bis(2-aminobenzamidoyl)hexane; 1,6-bis(2-aminobenzamidoyl)hexane; and 1,2-bis(2-aminobenzamidoyl)cyclohexane. More preferred are scavengers where the component molecular fragments are derived from anthranilamide, because of their low cost, efficacy, and ease of incorporation into PET.

An especially preferred scavenger of said class is 1,6-bis (2-aminobenzamidoyl hexane).

Another group of acetaldehyde scavengers suitable for use in the present invention include Anthranilamide, 1,8-diaminonaphalene, Allantoin, 3,4-diaminobenzoic acid, Malonamide, Salicylanilide, 6-amino-1,3-dimethyluracil (DMU), 6-Aminoisocytosine, 6-Aminouracil, 6-Amino-1-methyluracil, α-tocopherol, triglycerin, trimethylolpropane, dipentaerythritol, tripentaerythritol, D-mannitol, D-sorbitol, and xylitol. Suitable acetaldehyde scavengers may be as described in U.S. Pat. No. 6,936,204B and the content of the aforementioned as regards the scavengers is incorporated herein by reference. A said acetaldehyde scavenger may be a dextrin and/or cyclodextrin. From the aforementioned groups, Anthranilamide, 1,8-diaminonaphalene, Allantoin, 3,4-diaminobenzoic acid, Malonamide, Salicylanilide, 6-amino-1,3-dimethyluracil (DMU), 6-Aminoisocytosine, 6-Aminouracil, 6-Amino-1-methyluracil are preferred.

The most preferred scavenger is anthranilamide.

When said acetaldehyde decreasing compound is arranged to promote a reaction of the acetaldehyde, it may comprise a catalyst which may be arranged to be involved in the conversion of the acetaldehyde into ethanol, acetic acid and ethyl acetate. Said catalyst may be capable of catalysing a hydride-transfer reaction between an organic donor molecule and said acetaldehyde. Reactions of this type are known collectively as Meerwein-Ponndorf-Verley, Oppenauer, Cannizzaro, or Tishchenko reactions. Specific catalysts effective for the reduction of acetaldehyde in polyesters can be selected from those catalysts effective at catalyzing the Meerwein-Ponndorf-Verley, Oppenauer, Cannizzaro or Tishchenko reactions in the liquid or vapour phase. Those catalysts, for example, include the hydrous oxides of magnesium, calcium, strontium, barium, scandium, titanium, vanadium, chromium, manganese, iron, cobalt, nickel, zinc, aluminum, gallium, indium, tin, cadmium, niobium, zirconium, yttrium, hafnium, tantalum, lanthanum, and the rare earths. Suitable catalysts for use as described may be as described in US2005/0014929, the contents of which are incorporated by reference as regards the catalysts.

Said acetaldehyde decreasing compound may have a molecular weight (or number average molecular weight of said compound If polymeric) of less than 2000, suitably less than 1000, preferably less than 500, more preferably less than 250, especially less than 200. The molecular weight may be at least 100.

Said acetaldehyde decreasing compound may have a melting point of at least 75° C., preferably at least 100° C. The melting point may be less than 200° C., preferably less than 150° C.

Said acetaldehyde decreasing compound may have a decomposition temperature or boiling point, whichever is lower, of more than 150° C., preferably more than 200° C., more preferably more than 250° C.; and suitably less than 500° C., 400° C. or even 320° C.

Said acetaldehyde decreasing compound is preferably an acetaldehyde scavenger and, more preferably, is anthranilamide.

More than one acetaldehyde decreasing compound may be used. However, preferably only one is used.

Preferably, said polyester comprises a polyalkylene terephthalate such as polyethylene terephthalate or polybutylene terephthalate and copolymers thereof. Especially preferred is polyethylene terephthalate. Polyethylene terephthalate used for injection moulding purposes is typically post-condensed and has a molecular weight in the region of about 25,000 to 30,000. However, it has also been proposed to use a fibre grade polyethylene terephthalate that is cheaper but is non-post-condensed, with a lower molecular weight in the region of about 20,000. It has further been suggested to use co-polyethylene terephthalates of polyethylene terephthalate which contain repeat units from at least 85 mole % terephthalic acid and at least 85 mole % of ethylene glycol. Dicarboxylic acids which can be included, along with terephthalic acid, are exemplified by phthalic acid, isophthalic acid, naphthalene-2,6 dicarboxylic acid, cyclohexanedicarboxylic acid, cyclohexanediacetic acid, diphenyl-4,4′-dicarboxylic acid, succinic acid, glutaric acid, adipic acid, azelaic acid and sebacic acid. Other diols which may be incorporated in the co-polyethylene terephthalates, in addition to ethylene glycol, include diethylene glycol, triethylene glycol, 1,4-cyclohexanedimethanol, propane-1,3-diol, butane-1,4-diol, pentane-1,5-diol, hexane-1,6-diol, 3-methylpentane-2,4-diol, 2-methyl pentane-1,4-diol, 2,2,4-tri-methylpentane-1,3-diol, 2-ethylhexane-1,3-diol, 2,2-diethylpropane-1,3-diol, hexane-1,3-diol, 1,4-di(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane, and 2,2-bis-(4-hydroxypropoxyphenyl)-propane. In this specification the term “polyethylene terephthalate” includes not only polyethylene terephthalate but also such co-polyethylene terephthalates.

Said at least one material referred to in paragraph (ii) of the first aspect may be added to the polyester to adjust properties thereof. For example, it may be arranged to improve barrier properties of the polyester. Said one material will hereinafter be referred to as a “property improving material”. Said property improving material may be such that it has a tendency to increase haze and/or yellowing when added to a polyester. Use of said acetaldehyde decreasing compound may reduce the haze and/or yellowing.

When said property improving material contains an amino moiety, said moiety is preferably part of an amide group. The property improving material may itself be able to scavenge acetaldehyde but, for the avoidance of doubt, an additional acetaldehyde decreasing compound is used according to the first aspect. Preferably, the rate of scavenging by said acetaldehyde decreasing compound is significantly greater than the rate of scavenging (if any) by said property improving material.

When the property improving material is itself able to scavenge acetaldehyde, the relative rates of scavenging may be affected by the molecular weight of the acetaldehyde decreasing compound and/or property improving material. Preferably, the ratio of the molecular weight (the number average molecular weight in the case of a polymer) of said property improving material to that of the acetaldehyde decreasing compound, for example acetaldehyde scavenger, may be at least 2, suitably at least 10, preferably at least 50, more preferably at least 100, especially at least 500.

Said property improving material may comprise an aliphatic polyamide. It may be a fully aliphatic polyamide for example including a moiety —CO(CH₂)ₙCONH(CH₂)ₘNH— or a moiety —(CH₂)ₚCONH—, wherein n, m and p are integers in the range 1 to 10 suitably 4-6. Said property improving material may comprise a polyamide which is selected from the group consisting of partially aromatic polyamides. By “partially aromatic polyamide” it is meant that the amide linkage of the partially aromatic polyamide contains at least one aromatic ring and a non-aromatic species. Polyamides formed from isophthalic acid, terephthalic acid, cyclohexanedicarboxylic acid, meta- or para-xylylene diamine, 1,3- or 1,4-cyclohexane(bis)methylamine, aliphatic diacids with 6 to 12 carbon atoms, aliphatic amino acids or lactams with 6 to 12 carbon atoms, aliphatic diamines with 4 to 12 carbon atoms, and other generally known polyamide forming diacids and diamines can be used. The polyamides may also contain small amounts of trifunctional or tetrafunctional comonomers such as trimellitic anhydride, pyromellitic dianhydride, or other polyamide forming polyacids and polyamines known in the art.

Preferred partially aromatic polyamides include: poly(m-xylylene adipamide), poly(hexamethylene isophthalamide), poly(hexamethylene adipamide-co-isophthalamide), poly(hexamethyelene adipamide-co-terephthalamide), and poly(hexamethylene isophthalamide-co-terephthalamide). The most preferred partially aromatic polyamide is poly(m-xylene adipamide). Examples may have a number average molecular weight of 4,000 to 7,000 and an inherent viscosity of 0.3 to 0.6 dL/g. Preferred aliphatic polyamides include poly(hexamethylene adipamide) and poly(caprolactam). The most preferred aliphatic polyamide is poly(hexamethylene adipamide). Examples may have a number average molecular weight of 3,000 to 6,000 and an inherent viscosity of 0.4 to 0.9 dL/g.

When said property improving material comprises a nano clay, it may be selected from clays described and/or made as described in US2004/0087700 or EP0952187. Said nano clay may comprise a smectite clay. Preferred clays may include phyllosilicates such as smectite clay minerals e.g. montmorillonite, particularly sodium montmorillonite; bentonite; hectorite; saponite; stevensite; beidellite; and the like. Preferred smectite materials are bentonite and hectorite clays.

Preferably, said nano clay includes an ammonium, for example a quaternary ammonium compound. The N-containing moiety may be at least partially responsible for haze and yellowing when combined with polyester as described.

When said property improving material comprises a quaternary ammonium compound, said compound may include a moiety of formula:

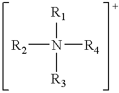

wherein R₁ comprises a group selected from (i) linear or branched aliphatic, aralkyl, or aromatic hydrocarbon groups having from 8 to 30 carbon atoms or (ii) alkyl or alkyl ester groups having 8 to 30 carbon atoms; R₂, R₃ and R₄ are independently selected from the group consisting of (a) linear or branched aliphatic, aralkyl and aromatic hydrocarbon fluorocarbon or other halocarbon groups having from 1 to about 30 carbon atoms, (b) alkoxylated groups containing from 1 to about 80 moles of alkylene oxide; (c) amide groups, (d) oxazolidine groups, (e) allyl, vinyl, or other alkenyl or alkynyl groups possessing reactive unsaturation and (f) hydrogen.

The raw materials used to make the quaternary ammonium compounds can be derived from natural oils such as tallow, soya, coconut and palm oil. Useful aliphatic groups in the above formula may be derived from other naturally occurring oils including various vegetable oils, such as corn oil, coconut oil, soybean oil, cottonseed oil, castor oil and the like, as well as various animal oils or fats. The aliphatic groups may likewise be petrochemically derived from, for example, alpha olefins. Representative examples of useful branched, saturated radicals included 12-methylstearyl and 12-ethylstearyl.

Examples of useful aromatic groups, that is benzyl and substituted benzyl moieties, include benzyl and benzylic-type materials derived from benzyl halides, benzhydryl halides, trityl halides, alpha-halo-alpha-phenylalkanes wherein the alkyl chain has from 1 to 30 carbon atoms, such as 1-halo-1-phenyloctadecane; substituted benzyl moieties, such as those derived from ortho-, meta- and para-chlorobenzyl halides, para-methoxybenzyl halides, ortho-meta- and para-nitrilobenzyl halides, and ortho-, meta- and para-alkylbenzyl halides wherein the alkyl chain contains from 1 to 30 carbon atoms; and fused ring benzyl-type moieties, such as those derived from 2-halomethylnaphthalene, 9-halomethylanthracene and 9-halomethylphenanthrene, wherein the halo group comprises chloro, bromo, or any other such group which serves as a leaving group in the nucleophilic attack of the benzyl type moiety such that the nucleophile replaces the leaving group on the benzyl type moiety.

Examples of other aromatic groups include aromatic-type substituents include phenyl and substituted phenyl, N-alkyl and N,N-dialkyl anilines, wherein the alkyl groups contain between 1 and 30 carbon atoms; ortho-, meta- and para-nitrophenyl, ortho-, meta- and para-alkyl phenyl, wherein the alkyl group contains between 1 and 30 carbon atoms, 2-,3-, and 4-halophenyl wherein the halo group is defined as chloro, bromo, or iodo, and 2-, 3-, and 4-carboxyphenyl and esters thereof, where the alcohol of the ester is derived from an alkyl alcohol, wherein the alkyl group contains between 1 and 30 carbon atoms, aryl such as phenol, or aralkyl such as benzyl alcohols; and fused ring aryl moieties such as naphthalene, anthracene, and phenanthrene.

Some examples of preferred cations of quaternary ammonium compounds are:

Dimethyl dihydrogenated tallow ammonium cation:

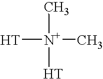

wherein HT=hydrogenated tallow.

Methyl bis[2-hydroxyethyl]stearyl ammonium cation:

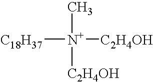

Dimethyl dibehenyl ammonium cation:

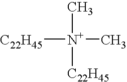

Methyl Iris[hydrogenated tallow alkyl]cation:

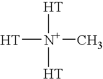

A preferred quaternary ammonium compound may comprise a quaternary ammonium salt that contains at least one, preferably two or three, hydrocarbon chains having from about 8 to about 30 carbon atoms and either no hydrophilic carbon chains or having hydrophilic radicals having a total of about 9 moles of ethylene oxide or less.

In one embodiment, said property improving material referred to in paragraph (ii) of the first aspect may be a hybrid organoclay which comprises a clay intercalate comprising an association between a clay as described and a quaternary ammonium compound and/or cation as described. Such materials are described in detail in US2004/0087700 and EP0952187A.

A promoter or catalyst may be included in the thermoplastic composition, together with said property improving material, especially with property improving materials which comprise aliphatic polyamides such as poly(hexamethylene adipamide) described above. Said catalyst may comprise a metal, preferably a transition metal, such as cobalt.

Preferably, said property improving material is included in the thermoplastic composition at a level at which it improves the properties of the composition. For example it may improve barrier properties as aforesaid. Said thermoplastic composition may include at least 0.5 wt %, preferably at least 1 wt %, more preferably at least 2 wt % of said property improving material. Said composition may include 20 wt % or less, preferably 15 wt % or less, more preferably 10 wt % or less, of said property improving material.

When said property improving material is a compound containing an amino moiety, for example an amide, said thermoplastic composition may include 0.5 wt % to 20 wt %, preferably 1 wt % to 10 wt %, more preferably 2 to 10 wt %, especially 3 to 8 wt % of said compound containing an amino moiety.

The ratio of the wt % of said polyester to said property improving material may be in the range 4 to 200, preferably 10 to 50, more preferably 10 to 25.

Any reference to “ppm” herein refers to parts per million by weight.

The amount of acetaldehyde decreasing compound, for example, acetaldehyde scavenger, used in the first aspect for the effect described may be in the range 100 to 5000 ppm based on the total weight of said thermoplastic composition, excluding the decreasing compound. Said amount may be in the range 200 to 750 ppm, preferably in the range 250 to 500 ppm.

Suitably, in said composition, after said acetaldehyde decreasing compound for example acetaldehyde scavenger has been added, the ratio of wt % of polyester to scavenger is in the range 450 to 3000, preferably in the range 1000 to 2500, more preferably in the range 1500 to 2500. Similarly, the ratio of the wt % of property improving material to acetaldehyde decreasing compound for example scavenger may be in the range 5 to 300, is preferably in the range 50 to 200 and is more preferably in the range 75 to 150.

Preferably, the acetaldehyde decreasing compound for example scavenger is such that when it is added to a said thermoplastic composition (and a 2.5 mm thick plaque is made as described hereinafter), the % transmission at 450 nm and/or 550 nm of the moulding composition which includes the acetaldehyde decreasing compound for example scavenger (e.g. the plaque) is greater than the % transmission measured in an identical manner on an identical material (e.g. plaque) except that such material does not include the acetaldehyde decreasing compound for example scavenger.

According to a second aspect of the invention, there is provided a method of reducing the degree of discolouration and/or increasing the degree of light transmission (i.e. reducing haze) of a thermoplastic moulding composition, the method comprising contacting a polyester, a property improving material (as described according to the first aspect) and an acetaldehyde decreasing compound (as described according to the first aspect), preferably an acetaldehyde scavenger.

The method preferably includes the step of blending the polyester, property improving material and acetaldehyde decreasing compound. The thermoplastic moulding composition is suitably comprised by said polyester and property improving material. It may comprise 80 to 99 wt % of polyester and 1 to 20 wt % of property improving material which may be any of the materials described according to the first aspect but is suitably a compound containing an amino moiety, preferably an amido moiety (especially MXD6 as herein referred to). Preferably, said composition includes 90 to 99 wt % of polyester and 1 to 10 wt % of property improving material. More preferably it includes 90 to 97 wt % of polyester and 3 to 10 wt % of property improving material. In said blending step 100 to 1500 ppm, preferably 500-1500 ppm of said acetaldehyde decreasing compound, for example scavenger, may be included.

The acetaldehyde decreasing compound (e.g. scavenger) may be added to the polyester and property improving material at any convenient stage. For example, it may be added to said thermoplastic moulding composition after the components of the composition have been mixed for example by extrusion. Alternatively, said polyester, property improving material and acetaldehyde decreasing compound (e.g. scavenger) may be blended. It is preferred that the polyester, property improving material and acetaldehyde decreasing compound (e.g. scavenger) are intimately mixed in the melt. For example, the polyester, property improving material and acetaldehyde decreasing compound (e.g. scavenger) may be mixed using an extrusion means. The method of the second aspect preferably includes the step of producing an article after the materials have been contacted and preferably intimately mixed as described. The article may be produced in a step which involves melting the thermoplastic composition. It may involve a moulding and/or extrusion process. In a preferred embodiment, an article is produced in a process which comprises intimately mixing polyester, property improving material and acetaldehyde decreasing compound (e.g. scavenger) at or above the melt temperature of the polyester, preferably by extrusion of the aforementioned materials; and subsequently treating the material produced, suitably in pellet form, in a further process (e.g. injection moulding) above the melt temperature of the polyester. Prior to or during said further process, further acetaldehyde decreasing compound (e.g. scavenger) (preferably the same compound intimately mixed with the polyester previously) may be contacted with the material and mixed therewith, suitably in a melt process such as injection moulding.

The article produced may be a packaging material especially for a bottle. It may be a bottle preform.

Any feature of the first aspect may be applied to said second aspect mutatis mutandis.

In the method of the second aspect and the use of the first aspect, the acetaldehyde decreasing compound (e.g. scavenger) may be added as a solid masterbatch in the form of granules or powder. Alternatively, the acetaldehyde decreasing compound (e.g. scavenger) may be suspended or dissolved in a liquid carrier in order to ensure a uniform dispersion of the additive throughout the polyester. The liquid carrier may be an inert material, such as a hydrocarbon oil, an ester, an alcohol, or a mixture of two or more thereof. The liquid carrier may be selected to be non-toxic, to have good compatibility with other ingredients and to possess good solvent properties (if the scavenger is to be dissolved in the liquid carrier). Ideally, the quantity of carrier included in the composition is kept to a minimum in order that the properties of the polyester are not adversely affected.

According to a third aspect of the invention, there is provided an article which comprises an acetaldehyde decreasing compound (e.g. scavenger) and a thermoplastic composition, wherein said thermoplastic composition comprises:

(i) a polyester; and
(ii) at least one material (herein referred to as a “property improving material”) selected from a compound containing an amino moiety, a nano clay and/or a quaternary ammonium compound.

Said article is preferably a moulded article, for example produced by a process which includes injection moulding. The article may be a bottle preform.

Any feature of the first and/or second aspects may be applied to said third aspect mutatis mutandis.

According to a fourth aspect, there is provided a method of making an article according to said third aspect, the method comprising:

(i) contacting an acetaldehyde decreasing compound (e.g. acetaldehyde scavenger), a polyester and a property improving material as described according to said first aspect;
(ii) subjecting the materials referred to in (i) to conditions for producing a moulded article.

The method preferably comprises selecting a source material, for example in pellet form, which includes said acetaldehyde decreasing compound, said polyester and said property improving material in step (i) and subjecting said source material to step (ii).

Step (ii) may include the step of incorporating further acetaldehyde decreasing compound into the source material and/or a moulded article being moulded therefrom.

Said conditions may comprise injection moulding the materials referred to in (i). The article may be a precursor for a packaging material, for example a bottle preform.

The invention extends to a formulation comprising an acetaldehyde decreasing compound (e.g. scavenger) and a thermoplastic composition, wherein said thermoplastic composition comprises:

(i) a polyester; and
(ii) at least one material (herein referred to as a “property improving material”) selected from a compound containing an amino moiety, a nano clay and/or a quaternary ammonium compound.

The formulation preferably is in the form of discrete units, for example pellets. It may comprise a polyester, an aliphatic or partially aromatic polyamide (especially MXD6) and an acetaldehyde scavenger, for example one which includes an —NH₂ moiety, especially anthranilamide.

The invention extends to a method of increasing the degree of light transmission (i.e. reducing haze) of an article made from a thermoplastic composition which comprises a polyester and a property improving material (as described according to the first aspect), the method comprising intimately mixing the polyester and property improving material by use of an extruder, forming extruded material into discrete units (e.g. pellets) and, subsequently, using said discrete units (e.g. solid units) to produce said article. Further acetaldehyde decreasing compound may be contacted with said discrete units in producing said article.

It has been found that, by using the process, the article produced may have reduced haze compared to that produced in a process which does not include said step of intimately mixing the components as described.

Preferably, in the method, said discrete solid units are used in a moulding process (e.g. an injection moulding process) to produce said article. Said article may be for a bottle; it may be a bottle preform.

Any feature of any aspect of any invention or embodiment described herein may be combined with any feature of any aspect of any other invention or embodiment described herein mutatis mutandis.

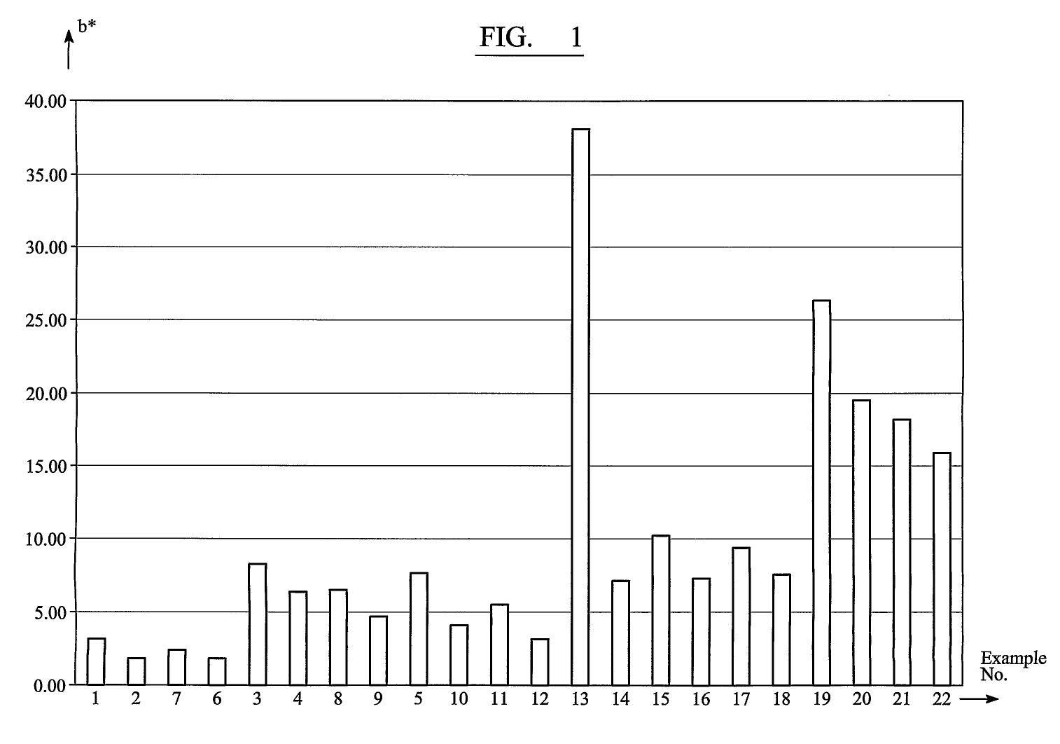

Specific embodiments of the invention will now be described by way of example, with reference to FIG. 1 which is a bar chart showing the b* for examples described.

The following materials are referred to hereinafter:

VORIDIAN 9921w—a copolymer PET obtained from Eastman Chemical Company.

Anthranilamide Dispersion—a dispersion comprising anthranilamide (33 wt %) in a mineral oil, obtained from Colormatrix, UK.

MXD6—an aromatic polyamide based on metaxylene diamine and adipic acid, obtained from Mitsubishi Chemical Company.

Imperm 103 (Trade Mark)—a barrier material for PET obtained from Nanocor, containing MXD6 and a nanoclay.

### EXAMPLE 1

VORIDIAN 9921 and MXD6 were dry blended in a 95:5 weight ratio and injection moulded into 3.0 mm thick plaques using a BOY22M injection moulding machine.

Optical analysis of the plaques showed them to have noticeable haze and considerable yellowing which was characterized by a b* value, obtained using a Minolta Spectrophotometer CM-3700D, of 3.18.

### EXAMPLE 2

The procedure of Example 1 was followed except that Anthranilamide Dispersion was added to deliver 500 ppm of anthranilamide at the dry blending stage and plaques were then moulded and assessed as described in the example.

It was found that the plaques had a similar amount of haze compared to the plaques of Example 1 but they exhibited significantly less yellowing, characterised by a b* value of 1.84, which represents approximately a 42% reduction in b* value.

### EXAMPLE 3

The procedure of Example 1 was followed except that the PET and MXD6 were pre-blended using a twin-screw extruder prior to the injection moulding stage.

It was found that the plaques exhibited a considerable reduction in haze compared to the plaques of Example 1, although they also exhibited considerable increase in the amount of yellowing (b* value of 8.4).

### EXAMPLE 4

The procedure of Example 3 was followed except that Anthranilamide Dispersion was added to deliver 500 ppm of active anthranilamide to the PET and MXD6 mixture after it has been extruded and the subsequent mixture was then subjected to an injection moulding stage and plaques produced.

It was found that the plaques exhibited low haze and a low b* value of 6.48. Thus, there was a significant reduction in the yellow value by addition of the acetaldehyde scavenger.

### EXAMPLE 5

The procedure of Example 3 was followed except that Anthranilamide Dispersion was added to deliver 500 ppm of active anthranilamide to the PET and MXD6 mixture before the mixture was extruded. The mixture was then extruded and subsequently injection moulded to prepare plaques.

It was found that the plaques exhibited low haze and a low b* value of 7.65 which represents a significant reduction in yellow generation compared to the plaques prepared as described in Example 3.

The procedure of the aforementioned examples, especially of Example 5, may be used to produce packaging materials, for examples bottles, having barrier layers which are not significantly affected by haze and/or yellowing.

### EXAMPLEs 6 to 22

Materials were assessed to determine the effect of adding an acetaldehyde scavenger to PET, optionally containing other additives, at various stages in procedures which may be used to make components out of PET.

In the examples, PET optionally containing additives may be subjected to the following steps:

(i) a first extrusion step using a twin screw extruder set at a 100 rpm screw speed and 5% feed rate to produce pellets;
(ii) a second step comprising drying the pellets for 15 hours at 160° C. For all examples, this drying stage was undertaken;
(iii) a third injection moulding step to produce plaques.

In the examples additives may be added prior to or concurrent with one or more of steps (i) to (iii). Also, cobalt, in the form of a 11.09 wt % solution of colbalt 2-ethylhexanoate which is arranged to deliver 30 ppm cobalt to the mixtures may be added. Cobalt is often used with MXD6 to improve its gas barrier properties. A summary of the examples is provided in Table 1 below which also includes a summary of Example 1 to 5.

TABLE 1

| | | | | | | | | Amount of |
|---|---|---|---|---|---|---|---|---|
| | | | | | Amount of | | Amount of | Cobalt |
| | Amount of | | Amount | Amount of | Cobalt | | anthranilamide | added at |
| | PET | Amount | of | Anthranilamide | added | Was the | dispersion added | injection |
| Example | (Voridian | of MXD6 | Imperm | dispersion added | into | mixture | into injection | moulding |
| No. | 9921) wt % | wt % | 103 wt % | into extruder | extruder | extruded? | moulder | stage |
| 1 | 95 | 5 | | | | No | | |
| 2 | 95 | 5 | | | | No | 500 | |
| 3 | 95 | 5 | | | | Yes | | |
| 4 | 95 | 5 | | | | Yes | 500 | |
| 5 | 95 | 5 | | 500 | | Yes | | |
| 6 | 95 | 5 | | | | No | 500 | 30 |
| 7 | 95 | 5 | | | | No | | 30 |
| 8 | 95 | 5 | | | | Yes | | 30 |
| 9 | 95 | 5 | | 500 | | Yes | 500 | 30 |
| 10 | 95 | 5 | | 500 | | Yes | 500 | |
| 11 | 95 | 5 | | 500 | | Yes | | 30 |
| 12 | 95 | 5 | | 500 | | Yes | 500 | 30 |
| 13 | 95 | 5 | | | 30 | Yes | | |
| 14 | 95 | 5 | | 500 | 30 | Yes | | |
| 15 | 95 | | 5 | | | No | | |
| 16 | 95 | | 5 | | | No | 500 | |
| 17 | 95 | | 5 | | | No | | 30 |
| 18 | 95 | | 5 | | | No | 500 | 30 |
| 19 | 95 | | 5 | | | Yes | | |
| 20 | 95 | | 5 | | | Yes | 500 | |
| 21 | 95 | | 5 | 500 | | Yes | | |
| 22 | 95 | | 5 | 500 | | Yes | 500 | |

FIG. 1 summarises some of the results which illustrate graphically the differences in yellowness (the lower the b*, the lower the yellowness).

The following may be noted from the results

(a) Nylon containing PET yellows on extrusion/injection moulding, and probably also during drying (compare examples 1 and 4)
(b) Addition of acetaldehyde scavenger at the extruder and injection moulding stages decrease discolouration (compare examples 1 and 2; 3 and 4; 21 and 22).
(c) Cobalt added to MXD6 mixtures tends to increase discolouration but such discolouration can be very significantly reduced by addition of acetaldehyde scavenger (compare examples 13 and 14).

1. The use of an acetaldehyde decreasing compound in a thermoplastic composition which comprises: (i) a polyester; and (ii) at least one property improving material selected from a compound containing an amino moiety, a nano clay and/or a quaternary ammonium compound; for reducing the degree of discolouration and/or increasing the degree of light transmission of an article formed from the thermoplastic composition.

2. The use according to claim 1, wherein said acetaldehyde decreasing compound is an acetaldehyde scavenger.

3. The use according to claim 1, wherein said scavenger includes amine moieties.

4. The use according to claim 1, wherein said acetaldehyde scavenger includes both amine moieties and amide moieties.

5. The use according to claim 1, wherein said acetaldehyde scavenger is anthranilamide or is an anthranilamide derivative.

6. The use according to claim 1, wherein said acetaldehyde scavenger is selected from: Anthranilamide,1,8-diaminonaphalene, Allantoin, 3,4-diaminobenzoic acid, Malonamide, Salicylanilide, 6-amino-I3-dimethyluracil (DMU), 6-Aminoisocytosine, 6-Aminouracil, 6-Amino-I-methyluracil, α-tocopherol, triglycerin, trimethylolpropane, dipentaerythritol, tripentaerythritol, D-mannitol, D-sorbitol, and xylitol.

7. The use according to claim 1, wherein said acetaldehyde scavenger is anthranilamide.

8. The use according to claim 1, wherein said acetaldehyde decreasing compound has a molecular weight of at least 100 and less than 500.

9. The use according to claim 1, wherein said acetaldehyde decreasing compound has a melting point of at least 75° C. and less than 200° C.; and a boiling point or decomposition temperature, whichever is lower, of more than 150° C.

10. The use according to claim 1, wherein the molecular weight or number average molecular weight in the case of a polymer of said property improving material to that of said acetaldehyde decreasing compound is at least 10.

11. The use according to claim 1, wherein said property improving material comprises an aliphatic polyamide or a partially aromatic polyamide.

12. The use according to claim 1, wherein said property improving material is selected from: poly(m-xylylene adipamide), poly (hexamethylene isophthalamide), poly (hexamethylene adipamide-co-isophthalamide), poly (hexamethyelene adipamide-co-terephthalamide) and poly (hexamethylene isophthalamide-co-terephthalamide).

13. The use according to claim 1, wherein said thermoplastic composition includes at least 0.5 wt % and 20 wt % or less of said property improving material.

14. The use according to claim 1, wherein the amount of acetaldehyde decreasing compound is in the range 100 to 5000 ppm based on the total weight of said thermoplastic composition.

15. A method of reducing the degree of discolouration and/or increasing the degree of light transmission of a thermoplastic moulding composition, the method comprising contacting a polyester, a property improving material selected from a compound containing an amino moiety, a nano clay and/or a quaternary ammonium compound; and an acetaldehyde decreasing compound.

16. A method according to claim 15, wherein the polyester, property improving material and acetaldehyde decreasing compound are intimately mixed in the melt.

17. A method according to claim 15, wherein prior to or during a further process, further acetaldehyde decreasing compound is contacted with materials and mixed therewith in a melt process.

18. An article which comprises an acetaldehyde decreasing compound and a thermoplastic composition, wherein said thermoplastic composition comprises: (i) a polyester; and (ii) at least one property improving material selected from a compound containing an amino moiety, a nano clay and/or a quaternary ammonium compound.

19. A method of making an article according to claim 18, the method comprising:
(i) contacting an acetaldehyde decreasing compound, a polyester and a property improving material selected from a compound containing an amino moiety, a nano clay and/or a quaternary ammonium compound; and
(ii) subjecting the materials referred to in (i) to conditions for producing a moulded article.

20. A formulation comprising an acetaldehyde decreasing compound and a thermoplastic composition, wherein said thermoplastic composition comprises: (i) a polyester; and (ii) at least one property improving material selected from a compound containing an amino moiety, a nano clay and/or a quaternary ammonium compound.

21. A formulation according to claim 20, said formulation comprising a multiplicity of discrete units, each substantially identical, wherein each unit comprises a polyester, a property improving material which is an aliphatic or partially aromatic polyamide and an acetaldehyde scavenger, wherein the ratio of the wt % of polyester to wt % of scavenger is in the range 1500 to 2500; the ratio of the wt % of property improving material to the wt % of scavenger is in the range 75 to 150; and the amount of scavenger is in the range 500 to 1500 ppm based on the weight of said thermoplastic composition.
